(19) United States
(12) Patent Application Publication
(10) Pub. No.: US 2008/0174531 A1
(43) Pub. Date: Jul. 24, 2008

(54) E-PAPER APPARATUS AND MANUFACTURING METHOD THEREOF

(76) Inventor: Wen-Jyh SAH, Tainan City (TW)

Correspondence Address: BIRCH STEWART KOLASCH & BIRCH, PO BOX 747, FALLS CHURCH, VA, 22040-0747, US

(21) Appl. No.: 12/018,081

(22) Filed: Jan. 22, 2008

(30) Foreign Application Priority Data
Jan. 22, 2007 (TW) 096102399

(51) Int. Cl. G09G 3/34

(52) U.S. Cl. 345/84

(57) ABSTRACT

An electronic paper (e-paper) apparatus includes a driving substrate, an electronic paper and an optical modulation layer. The electronic paper includes an electrophoretic material and a transparent electrode layer. The transparent electrode layer is disposed opposite to the driving substrate. The optical modulation layer is disposed on the electronic paper. A manufacturing method of the electronic paper apparatus is also disclosed.

### CROSS REFERENCE TO RELATED APPLICATIONS

This Non-provisional application claims priority under 35 U.S.C. §119(a) on Patent Application No(s). 096102399 filed in Taiwan, Republic of China on Jan. 22, 2007, the entire contents of which are hereby incorporated by reference.

### BACKGROUND OF THE INVENTION

1. Field of Invention

The invention relates to a display apparatus and a manufacturing method thereof. More particularly, the invention relates to an electronic paper display apparatus and a manufacturing method thereof.

2. Related Art

In the information era, the demands of users for communicating with information sources are increasing. Therefore, the display apparatus that can broadcast information has become one of the indispensable electronic products in modern life. The display apparatus has evolved from the cathode ray tube (CRT) display to the modern liquid crystal display (LCD) that is thinner and lighter. Accordingly, the LCD has been widely used in communications, information and consumer electronics. However, the LCD has to be continuously powered in order to operate. Therefore, the display technology of electrophoretic display (EPD) with lower power consumption has been invented.

Now, computers are often used to process and store large amount of data. However, the volume, weight and operation of computer are not as convenient in carrying and reading as what of printed information on paper. To enjoy the portability and convenience in reading of paper while having the capabilities to process data and be environmentally friendly, electronic paper using the EPD is disclosed.

As shown in FIG. 1, according to the electrophoretic principle, a conventional electronic paper apparatus 1 can produce colors by driving electrically charged particles with an electric field. The electronic paper apparatus 1 includes a driving substrate 11 and an electronic paper 12. The electronic paper 12 is disposed on the driving substrate 11. The driving substrate 11 has a patterned pixel electrode layer 111. The electronic paper 12 has an upper substrate 121, an electrophoretic material 122 and an adhesive layer 123. The electrophoretic material 122, including electrically charged particles C1 and a dielectric solvent L1, is sealed between the upper substrate 121 and the adhesive layer 123. A transparent electrode layer 124 is formed at one side of the upper substrate 121, and is disposed opposite to the pixel electrode layer 111.

When a potential difference is applied between the pixel electrode layer 111 and the transparent electrode layer 124, the electrically charged particles C1 move toward the pixel electrode layer 111 or the transparent electrode layer 124, which carries charges with the polarity opposite to those of the electrically charged particles. Therefore, by selectively applying a voltage between the two electrode layers 111 and 124, the color of the dielectric solvent L1 or the electrically charged particles C1 can be determined. Then, the displayed color is changed by applying a reverse voltage.

As shown in FIG. 1, the electrophoretic material 122 between the upper substrate 121 and the adhesive layer 123 encapsulates the electrically charged particles C1 and the dielectric solvent L1 into a capsule using the microencapsulation technology. In addition, as shown in FIG. 2, an alternative approach is to form microcups to dispose the electrophoretic materials 122 therein separately. In order to achieve the object of full-color display, the separated electrophoretic materials 122 may respectively carry three primary colors. By properly arranging the separated electrophoretic materials 122, the full-color frame can be presented. In addition, a plurality of color filters 13 may be formed on a package cover plate 14, and then the color filters 13 are aligned with the driving substrate 11 so that the patterns of the color filters 13 are aligned with the pixel electrode layer 111 on the driving substrate 11, as shown in FIG. 3, and the full-color can be displayed.

However, the conventional approach of achieving the full-color display is to precisely arrange the separated electrophoretic materials 122 and align the color filters 13 on the cover plate 14 with the pixel electrode layer 111 of the driving substrate 11. Therefore, the complexity of the manufacturing process is increased. In addition, the proper aligning apparatus and technique have to be correspondingly provided, and the manufacturing cost of the electronic paper apparatus 1 is also increased.

Therefore, it is an important subject to provide an electronic paper apparatus and a manufacturing method thereof, which have the full-color displaying effect and may be manufactured with simplified steps and lowered cost.

### SUMMARY OF THE INVENTION

In view of the foregoing, the invention is to provide an electronic paper apparatus and a manufacturing method thereof, which have the full-color displaying effect and may be manufactured with simplified steps and lowered cost.

To achieve the above, the invention discloses an electronic paper apparatus including a driving substrate, an electronic paper and an optical modulation layer. The electronic paper includes an electrophoretic material and a transparent electrode layer disposed opposite to the driving substrate. The optical modulation layer is disposed on the electronic paper.

In addition, the invention also discloses a manufacturing method of an electronic paper apparatus. The method includes the steps of: disposing an electronic paper over a driving substrate, wherein the electronic paper includes an electrophoretic material and a transparent electrode layer, and the transparent electrode layer is disposed opposite to the driving substrate; and ink jetting or printing an optical modulation layer on the electronic paper.

As mentioned above, the optical modulation layer of the electronic paper apparatus in the invention is disposed on the electronic paper and disposed over the transparent electrode. Compared with the prior art, the optical modulation layer of the invention may be formed on the electronic paper and opposite to the pixel electrode of the driving substrate by way of ink jetting or printing. Thus, the conventional aligning step, which is performed after the optical modulation layer is disposed on the package cover plate, may be omitted. In addition, the complicated processes of arranging the electrophoretic materials for three primary colors to achieve the full-color display may be omitted. Therefore, the manufacturing cost is effectively decreased, and the product yield is increased.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration showing a conventional electronic paper apparatus;

FIGS. 2 and 3 are a pair of schematic illustrations showing another conventional electronic paper apparatus;

FIG. 4 is a schematic illustration showing an electronic paper apparatus according to an embodiment of the invention;

FIG. 5 is a schematic illustration showing another electronic paper apparatus according to the embodiment of the invention;

FIG. 6 is a schematic illustration showing the electronic paper apparatus and a package structure according to the embodiment of the invention; and

FIG. 7 is a flow chart showing a manufacturing method of the electronic paper apparatus according to the embodiment of the invention.

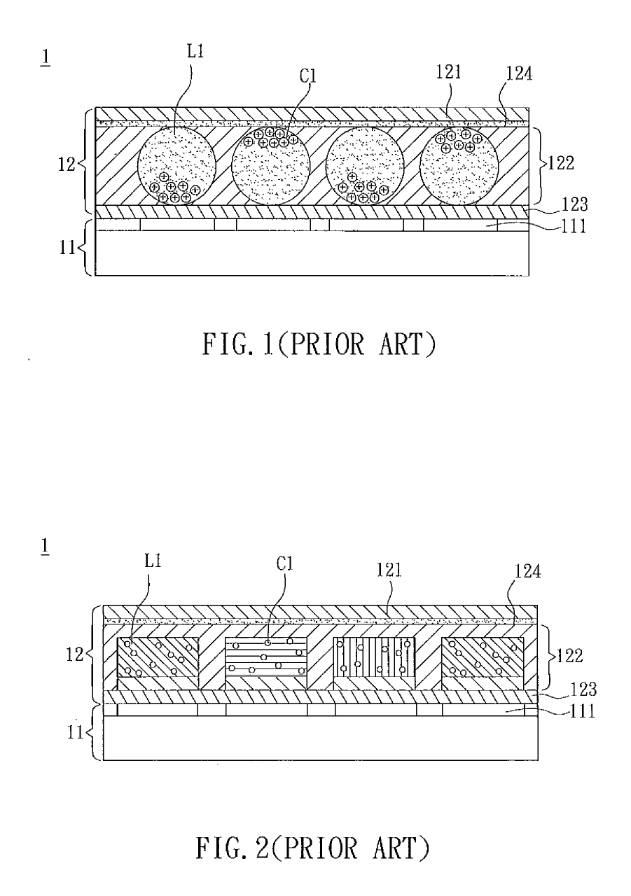

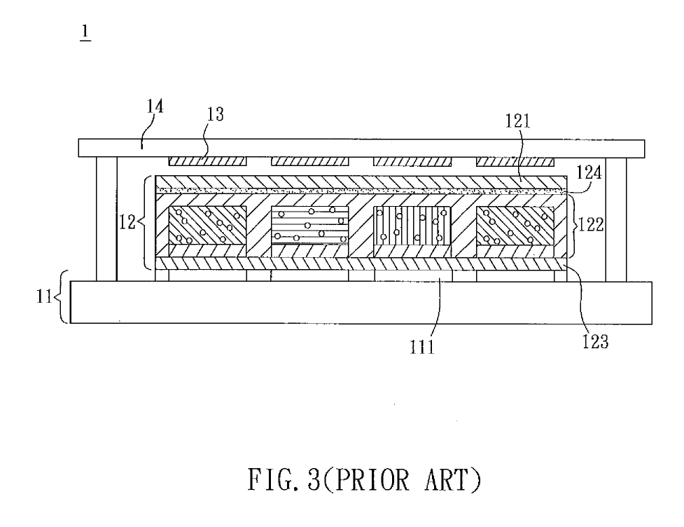

### DETAILED DESCRIPTION OF THE INVENTION

The present invention will be apparent from the following detailed description, which proceeds with reference to the accompanying drawings, wherein the same references relate to the same elements.

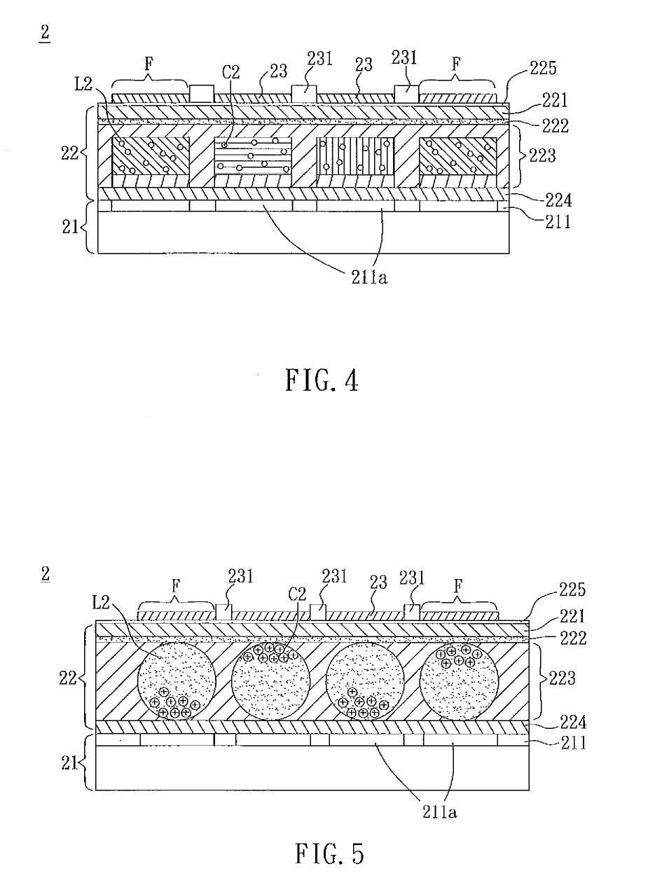

Referring to FIG. 4, an electronic paper apparatus 2 according to a preferred embodiment of the invention includes a driving substrate 21, an electronic paper 22 and an optical modulation layer 23. In this embodiment, the electronic paper apparatus 2 is a reflective type electrophoresis display apparatus.

The driving substrate 21 includes a pixel electrode layer 211, which may include a plurality of pixel electrodes 211a. In the embodiment, the driving substrate 21 may be a glass substrate, a plastic substrate, a printed circuit board or a flexible circuit board. The pixel electrodes 211a of the pixel electrode layer 211 are arranged in an array so that the driving substrate 21 is driven by way of active matrix array driving or passive matrix array driving. In the embodiment, the driving substrate 21 is driven by way of active matrix array driving in this example.

The electronic paper 22 is disposed over the driving substrate 21, especially disposed over the pixel electrode layer 211. The electronic paper 22 includes an upper substrate 221, a transparent electrode layer 222, an electrophoretic material 223 and an adhesive layer 224 disposed opposite to the upper substrate 221. The transparent electrode layer 222 is disposed at one side of the upper substrate 221. The electrophoretic material 223 is disposed between the upper substrate 221 and the adhesive layer 224. That is, the electrophoretic material 223 is disposed between the transparent electrode layer 222 and the pixel electrode layer 211. The electrophoretic material 223 includes a plurality of pigment particles C2 and a dielectric solvent L2. The pigment particles C2 are dispersed over the dielectric solvent L2. In the embodiment, the electrophoretic material 223 is accommodated within, for example but not limited to, a microcup structure. Of course, the electrophoretic material 223 may also cover a micro-capsule structure (see FIG. 5). Either the electrophoretic material 223 is accommodated in the microcup structure or covers the micro-capsule structure, each pixel electrode 211a may not be aligned with each microcup structure or each micro-capsule structure.

As mentioned above, the transparent electrode layer 222 is disposed corresponding to the pixel electrode layer 211 of the driving substrate 21. Herein, the transparent electrode layer 222 may also be referred to as a common electrode layer. The transparent electrode layer 222 is disposed opposite to the pixel electrodes 211a. So, when a voltage difference is applied between the electrode layers 211 and 222, the pigment particles C2 are driven to reflect light rays on a display surface to present the color of the pigment particles C2 or the dielectric solvent L2. In the embodiment, the material of the transparent electrode layer 222 may be indium tin oxide (ITO), aluminum zinc oxide, indium zinc oxide or cadmium tin oxide.

In addition, the driving substrate 21 of the embodiment may further include a plurality of thin film transistors for driving the pixel electrode layer 211 so that the active electrode driving design is obtained. The thin film transistors may be formed on the driving substrate 21 and arranged in an array by the amorphous silicon (amorphous Si) or low-temperature polysilicon manufacturing process. The thin film transistors are connected to the pixel electrodes 211a to serve as driving switches.

In the embodiment, the optical modulation layer 23 is disposed on the electronic paper 22 and is formed over the transparent electrode layer 222 by way of ink jetting or printing. That is, the optical modulation layer 23 may be formed on the surface of the upper substrate 221 of the electronic paper 22 directly by way of ink jetting or printing on the structure of the conventional electronic paper. The optical modulation layer 23 may include at least one filtering material or at least one color converting material. The filtering material may be selected from at least one of a red filtering material, a blue filtering material and a green filtering material to achieve the fill-color display. The color converting material may include a fluorescent material and/or a phosphorus material so that multiple colors are achieved by mixing, scattering and exciting the passing light. In this embodiment, the optical modulation layer 23 is disposed corresponding to the pixel electrode layer 211. That is, the filtering material or the color converting material in the optical modulation layer 23 is aligned with the pixel electrode 211a on the pixel electrode layer 211.

In order to enhance the connection strength between the optical modulation layer 23 and the upper substrate 221 of the electronic paper 22, a roughing structure (not shown) is formed on the connecting surface between the upper substrate 221 and the optical modulation layer 23. The roughness of the surface structure assists in the material adhering of the optical modulation layer 23. In addition to enhancing the connection strength between the optical modulation layer 23 and the upper substrate 221 by the roughing structure, the electronic paper apparatus 2 may further include an ink-jet auxiliary layer 225 disposed between the optical modulation layer 23 and the upper substrate 221 (i.e., disposed on the connection interface between the optical modulation layer 23 and the upper substrate 221), as shown in FIGS. 4 and 5. To be noted, the ink-jet auxiliary layer 225 can also be a printed auxiliary layer. In this embodiment, the material of the ink-jet auxiliary layer 225 may be glue. The material of the optical modulation layer 23 is adhered according to the property of the glue so that the strength of the connection interface can be effectively enhanced.

In addition, the electronic paper apparatus 2 of the embodiment may further include a barrier layer 231, which is formed over the upper substrate 221 (i.e., disposed on the connection surface between the upper substrate 221 and the optical modulation layer 23) by way of ink jetting or printing. The barrier layer 231 may be a black matrix layer which defines a plurality of filtering areas F. The filtering material or the color converting material of the optical modulation layer 23 is disposed in the filtering areas F. The provision of the barrier layer 231 prevents the materials of the optical modulation layer 23 between the filtering areas F from producing the alternately mixed phenomenon.

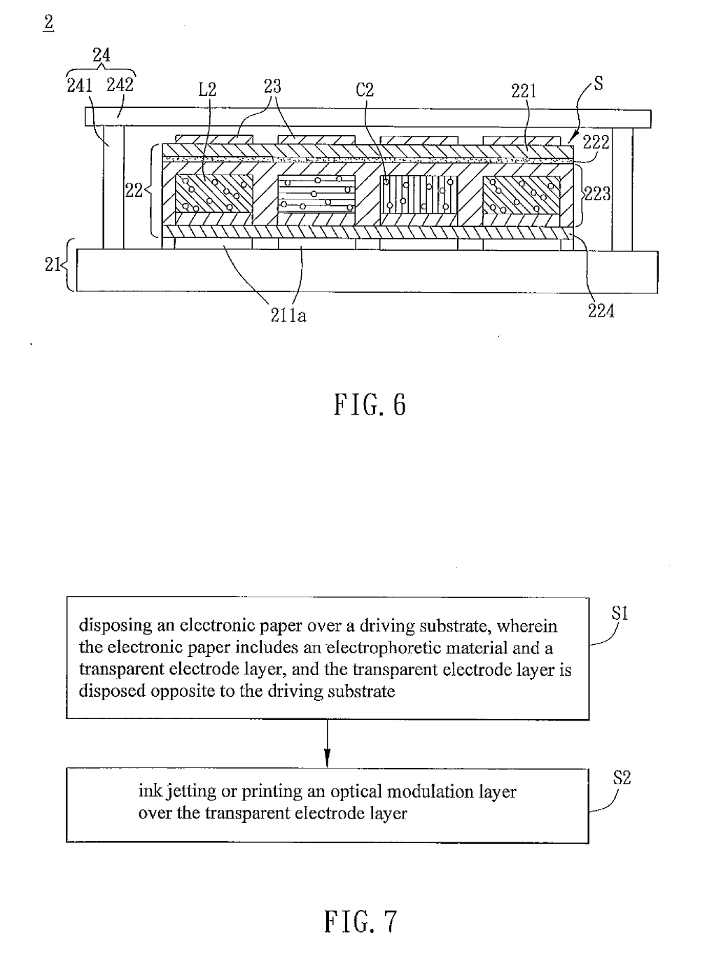

Referring to FIG. 6, the electronic paper apparatus 2 may further include a package structure 24, which is connected to the driving substrate 21 to form a closed space S for accommodating the electronic paper 22 and the optical modulation layer 23, in order to achieve the better moisture blocking effect. In the embodiment the package structure 24 includes an adhesive 241 and a covering plate 242. The adhesive 241 connects the covering plate 242 to the driving substrate 21 in order to effectively stop the external moisture from entering the closed space S to influence the operation of the electronic paper 22. The covering plate 242 may be a transparent covering plate made of a glass material.

Referring to FIG. 7, a manufacturing method of the electronic paper apparatus according to the preferred embodiment of the invention includes steps S1 and S2. In the step S1, an electronic paper is disposed over a driving substrate. The electronic paper includes an electrophoretic material and a transparent electrode layer disposed opposite to the driving substrate. In the step S2, an optical modulation layer is formed over the transparent electrode layer by way of ink jetting or printing.

With reference to FIGS. 4 and 7, the driving substrate in the step S1 includes a pixel electrode layer 211, and the electronic paper 22 is disposed over the pixel electrode layer 211. The driving substrate 21 further includes a plurality of thin film transistors for driving the pixel electrode layer 211. The pixel electrodes 211a of the pixel electrode layer 211 are arranged in an array so that the driving substrate 21 is driven by way of active matrix array driving or passive matrix array driving. In the embodiment, the driving substrate 21 is driven by way of active matrix array driving in this example.

The step of disposing the electronic paper 22 over the driving substrate 21 will be described in detail in the following. First, an adhesive layer 224 is disposed over the driving substrate 21. Of course, the adhesive layer 224 may also be disposed on the surface of the electronic paper 22. Next, the electronic paper 22 is adhered to the driving substrate 21. The electronic paper 22 further includes an upper substrate 221, the transparent electrode layer 222 is disposed at one side of the upper substrate 221, and the transparent electrode layer 222 is disposed between the upper substrate 221 and the driving substrate 21.

In the step S2, the optical modulation layer 23 is formed on the electronic paper 22 by way of ink jetting or printing. More particularly, the optical modulation layer 23 is disposed on the upper substrate 221. Before this step S2, the manufacturing method of the electronic paper apparatus 2 may further include a step of aligning an ink jetting apparatus or a printing apparatus with the driving substrate 21 so as to define the position of the optical modulation layer 23. Herein, the driving substrate 21 may be formed with at least one positioning mark to facilitate the positioning between the ink jetting apparatus or the printing apparatus and the driving substrate 21. Thus, the arranging position of the optical modulation layer 23 can be defined so that the optical modulation layer 23 can be aligned with the pixel electrode layer 211 of the driving substrate 21.

In addition, the manufacturing method may further include, before the step S2, a step of forming a roughing structure on the surface of the upper substrate 221. The surface is a surface of the upper substrate 221 on which the optical modulation layer 23 is disposed. The roughing structure can enhance the connection strength between the upper substrate 221 and the optical modulation layer 23. In addition the manufacturing method may further include the step of disposing an ink-jet auxiliary layer 225 between the optical modulation layer 23 and the upper substrate 221. That is, the ink-jet auxiliary layer 225 is firstly formed on the upper substrate 221 to assist in the material adhering of the subsequent optical modulation layer 23 so that the better connection strength is obtained. The material of the ink-jet auxiliary layer 225 may be glue, for example.

In addition, the manufacturing method of this embodiment may further include the step of disposing a barrier layer 231 on the surface of the upper substrate 221 by way of ink jetting or printing. That is, the barrier layer 231 is formed on the surface of the upper substrate 221, on which the optical modulation layer 23 is to be formed. More particularly, a black matrix layer may be formed to serve as the barrier layer 231 for defining a plurality of filtering areas F, in which the optical modulation layer 23 to be aligned with the pixel electrode 211a is disposed. The barrier layer 231 can effectively prevent the material of the optical modulation layer 23 from mixing alternately.

In order to achieve the optimum operation state of the electronic paper apparatus 2, the manufacturing method of this embodiment further includes the step of providing a package structure 24 connected to the driving substrate 21 to from a closed space S for accommodating the electronic paper 22 and the optical modulation layer 23 and to prevent the external moisture and oxygen from entering the space, as shown in FIG. 6.

In summary, the optical modulation layer of the electronic paper apparatus in the invention is disposed on the electronic paper and disposed over the transparent electrode. Compared with the prior art, the optical modulation layer of the invention may be formed on the electronic paper and opposite to the pixel electrode of the driving substrate by way of ink jetting or printing. Thus, the conventional aligning step, which is performed after the optical modulation layer is disposed on the package cover plate may be omitted. In addition, the complicated processes of arranging the electrophoretic materials for three primary colors to achieve the full-color display may be omitted. Therefore, the manufacturing cost can be effectively decreased, and the product yield can be increased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An electronic paper apparatus, comprising:
a driving substrate;
an electronic paper, which is disposed over the driving substrate and comprises an electrophoretic material and a transparent electrode layer disposed opposite to the driving substrate; and
an optical modulation layer disposed on the electronic paper.

2. The electronic paper apparatus according to claim 1, wherein the optical modulation layer is formed on the electronic paper by way of ink jetting or printing.

3. The electronic paper apparatus according to claim 1, wherein the optical modulation layer comprises at least one filtering material or at least one color converting material.

4. The electronic paper apparatus according to claim 3, wherein the filtering material at least comprises a red filtering material, a blue filtering material or a green filtering material, and the color converting material comprises a fluorescent material and/or a phosphorus material.

5. The electronic paper apparatus according to claim 1, wherein the driving substrate comprises a glass substrate, a plastic substrate, a printed circuit board or a flexible printed circuit board.

6. The electronic paper apparatus according to claim 1, wherein the driving substrate comprises a pixel electrode layer, and the electronic paper is disposed over the pixel electrode layer.

7. The electronic paper apparatus according to claim 6, wherein the pixel electrode layer is arranged in an array.

8. The electronic paper apparatus according to claim 1, wherein the driving substrate is driven by way of active matrix array driving.

9. The electronic paper apparatus according to claim 6, wherein a pattern of the optical modulation layer is aligned with a pattern of the pixel electrode layer.

10. The electronic paper apparatus according to claim 6, wherein the electrophoretic material is disposed between the transparent electrode layer and the pixel electrode layer.

11. The electronic paper apparatus according to claim 1, wherein the electronic paper further comprises:
an upper substrate, wherein the transparent electrode layer is disposed at one side of the upper substrate, and the transparent electrode layer is disposed between the upper substrate and the driving substrate.

12. The electronic paper apparatus according to claim 11, wherein the optical modulation layer is disposed on a surface of the upper substrate.

13. The electronic paper apparatus according to claim 11, wherein a surface of the upper substrate has a roughing structure.

14. The electronic paper apparatus according to claim 11, further comprising:
an ink-jet or printed auxiliary layer disposed between the optical modulation layer and the upper substrate.

15. The electronic paper apparatus according to claim 11, further comprising:
a barrier layer disposed on a surface of the upper substrate, wherein the barrier layer defines a plurality of filtering areas, and the optical modulation layer is disposed in the filtering areas.

16. The electronic paper apparatus according to claim 15, wherein the barrier layer is a black matrix layer.

17. The electronic paper apparatus according to claim 1, wherein the electronic paper further comprises:
an adhesive layer disposed between the electrophoretic material and the driving substrate.

18. The electronic paper apparatus according to claim 1, further comprising:
a package structure connected to the driving substrate to form a closed space for accommodating the electronic paper and the optical modulation layer.

19. The electronic paper apparatus according to claim 18, wherein the package structure comprises an adhesive and a covering plate, the adhesive connects the covering plate to the driving substrate, and the covering plate is substantially a transparent covering plate.

20. The electronic paper apparatus according to claim 19, wherein a material of the covering plate comprises glass.

21. A manufacturing method of an electronic paper apparatus, the method comprising steps of:
disposing an electronic paper over a driving substrate, wherein the electronic paper comprises an electrophoretic material and a transparent electrode layer, and the transparent electrode layer is disposed opposite to the driving substrate; and
ink jetting or printing an optical modulation layer on the electronic paper.

22. The method according to claim 21, wherein the driving substrate comprises a pixel electrode layer, the electronic paper is disposed over the pixel electrode layer, and the pixel electrode layer has a plurality of pixel electrodes, which are arranged in an array.

23. The method according to claim 21, wherein the driving substrate is driven by way of matrix active array driving.

24. The method according to claim 21, wherein the electrophoretic material is disposed between the transparent electrode layer and the pixel electrode layer.

25. The method according to claim 21, wherein a pattern of the optical modulation layer is aligned with a pattern of the pixel electrode layer.

26. The method according to claim 21, wherein the step of disposing the electronic paper comprises:
disposing an adhesive layer on a surface of the driving substrate or the electronic paper; and
adhering the driving substrate to the electronic paper.

27. The method according to claim 21, wherein the optical modulation layer is disposed on a surface of an upper substrate.

28. The method according to claim 27, further comprising a step of:
forming a roughing structure on a surface of the upper substrate.

29. The method according to claim 27, further comprising a step of:
disposing an ink-jet or printed auxiliary layer between the optical modulation layer and the upper substrate.

30. The method according to claim 27, further comprising a step of:
disposing a barrier layer on a surface of the upper substrate, wherein the barrier layer defines a plurality of filtering areas, and the optical modulation layer is disposed in the filtering areas.

31. The method according to claim 30, wherein the barrier layer is a black matrix layer.

32. The method according to claim 21, further comprising a step of:
aligning an ink jetting apparatus or a printing apparatus with the driving substrate.

33. The method according to claim 21, further comprising a step of:
providing a package structure, wherein the package structure is connected to the driving substrate to form a closed space for accommodating the electronic paper and the optical modulation layer.
